(19) United States
(12) Patent Application Publication
(10) Pub. No.: US 2020/0413009 A1
(43) Pub. Date: Dec. 31, 2020

(54) BIDIRECTIONAL VIDEO COMMUNICATION SYSTEM AND KIOSK TERMINAL

(71) Applicant: PANASONIC INTELLECTUAL PROPERTY MANAGEMENT CO., LTD., Osaka (JP)

(72) Inventors: Kazuyuki HORIO, Tokyo (JP); Issei IKEZAKI, Fukuoka (JP)

(73) Assignee: PANASONIC INTELLECTUAL PROPERTY MANAGEMENT CO., LTD., Osaka (JP)

(21) Appl. No.: 16/975,608

(22) PCT Filed: Feb. 7, 2019
(86) PCT No.: PCT/JP2019/004508

§ 371 Date: Aug. 25, 2020

(30) Foreign Application Priority Data
Feb. 26, 2018 (JP) 2018-032233

(51) Int. Cl. H04N 7/15; H04N 7/14; G06F 3/16

(52) U.S. Cl. CPC H04N 7/157; G06F 3/167; H04N 7/142

(57) ABSTRACT

In order to enable a kiosk terminal to respond to a user for providing services in either way, through avatar-based communication with an avatar as a human proxy or through face-to-face communication with an operator, depending on the type of service required by the user, a controller of the kiosk terminal is configured such that, in an operator display mode, the controller displays the video of the operator on a monitor concurrently with outputting an original sound of the operator's voice from a speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

### TECHNICAL FIELD

The present invention relates to a bidirectional video communication system for communication between a kiosk terminal and an operator terminal, the system being configured to bidirectionally transmit a video of a user who operates the kiosk terminal and a video of an operator who operates the operator terminal between the kiosk terminal and the operator terminal, and a kiosk terminal used in the system.

### BACKGROUND ART

In recent years, bidirectional video communication systems for bidirectional transmission of videos of a plurality of persons remotely located from one another. Meanwhile, kiosk terminals are widely used for providing services such as guidance services (providing various types of information) and teller services at financial institutions, taking the place of human operators. Thus, building up a bidirectional video communication system between such a kiosk terminal and an operator terminal operated by an operator enables the operator to provide a face-to-face response to a user, which improves quality of services provided by the kiosk terminal.

Known technologies related to such a bidirectional video communication system which can be built in a kiosk terminal include a kiosk terminal provided with a plurality of monitors including a front-facing monitor facing a use, the front-facing monitor being used to display a face of an operator (Patent Document 1).

Moreover, in cases where it is undesirable to directly display a video of a person shot at one terminal on a monitor of a counterpart terminal, since voice-only communications cannot ensure adequate communications between persons, one of the known technologies provides a system configured to generate, based on feature information including features extracted from a face image of a person at one terminal, a video of an avatar (mascot) as a human proxy, the avatar reproducing changes in facial expressions of the person, and display the video of the avatar on a counterpart terminal (Patent Document 2).

### PRIOR ART DOCUMENT (S)

### Patent Document(S)

Patent Document 1: JP2004-147105A
Patent Document 2: JP3593067B

### SUMMARY OF THE INVENTION

### Task to be Accomplished by the Invention

In a bidirectional video communication system built for communication between a kiosk terminal and an operator terminal, the kiosk terminal displays a frontal-face video of an operator on a monitor thereof. However, since some operators do not want to expose their faces, a system needs to be configured such that even operators who do not want to expose their faces can do tasks which require no exposure of their faces, in view of the need for effective use of human resources. Such operators' need can be satisfied by a system configured to display a video of an avatar as a human proxy as disclosed in Patent Document 2. However, an operator's face-to-face communication with a user is sometimes needed depending on the type of service required by the user, and thus, there is a need for a system which is adapted for avatar-based communication, and also configured such that an operator can also directly respond to a user as necessary.

However, the above-described prior art involves a problem that a kiosk terminal is not allowed to respond to a user for providing services in either way, through avatar-based communication with an avatar as a human proxy or through face-to-face communication with an operator, depending on the type of service required by the user.

The present invention has been made in view of such problems of the prior art, and a primary object of the present invention is to provide a bidirectional video communication system and a kiosk terminal used therein, which enables a kiosk terminal to respond to a user for providing services in either way, through avatar-based communication with an avatar as a human proxy or through face-to-face communication with an operator, depending on the type of service required by the user.

### Means to Accomplish the Task

An aspect of the present invention provides a bidirectional video communication system for communication between a kiosk terminal and an operator terminal, the system being configured to bidirectionally transmit a video of a user who operates the kiosk terminal and a video of an operator who operates the operator terminal between the kiosk terminal and the operator terminal, wherein the operator terminal comprises: a communication device configured to perform communication with the kiosk terminal; a camera configured to shoot a frontal-face video of the operator; a microphone configured to pick up a sound of the operator's voice; and a controller, and wherein the kiosk terminal comprises: a communication device configured to perform communication with the operator terminal; a monitor configured to display the frontal-face video of the operator shot by the camera; a speaker configured to output an original sound of the operator's voice picked up by the microphone; a controller, wherein the controller of the kiosk terminal is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

Another aspect of the present invention provides a kiosk terminal for bidirectional communication with an operator terminal, the kiosk terminal being configured for bidirectional transmission of a video of a user who operates the kiosk terminal and a video of an operator who operates the operator terminal to and from the operator terminal, the kiosk terminal comprising: a communication device configured to perform communication with the operator terminal; a camera configured to shoot a frontal-face video of the operator; a monitor configured to display a video of the operator shot by a camera of the operator terminal; a speaker configured to output an original sound of the operator's voice picked up by a microphone of the operator terminal; and a controller, wherein the controller is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

### Effect of the Invention

According to the present invention, a system is configured such that, in an operator display mode, a kiosk terminal displays a video of an operator so that the operator can directly respond to a user whereas, in an avatar display mode, the kiosk terminal displays a video of an avatar so that the avatar can respond to the user as an operator's proxy. As a result, the system can respond to the user for providing services in either way, through avatar-based communication with an avatar as a human proxy or through face-to-face communication with the operator, depending on the type of service required by the user. Since, even in the avatar display mode, the kiosk terminal outputs an original sound of the operator's voice, the system can avoid providing a feeling of strangeness to the user.

### BRIEF DESCRIPTION OF THE DRAWINGS

FIG. 1 is a diagram showing a general configuration of a bidirectional video communication system according to an embodiment of the present invention;

FIG. 2 is a perspective view showing a kiosk terminal 1;

FIG. 3 is a perspective view showing an operator terminal 2;

FIG. 4 is a block diagram showing schematic configurations of the kiosk terminal 1 and the operator terminal 2;

FIG. 5 is an explanatory diagram showing screens displayed on the kiosk terminal 1;

FIG. 6 is an explanatory diagram showing screens displayed on the operator terminal 2; and

FIG. 7 is an explanatory diagram showing screens displayed on the operator terminal 2;

FIG. 8 is an explanatory diagram showing records registered in an avatar database managed by the operator terminal 2;

FIG. 9 is a flow chart showing an operation procedure of a screen control operation performed by the operator terminal 2 on a front-facing monitor 12 of the kiosk terminal 1;

FIG. 10 is a flow chart showing an operation procedure of a screen control operation performed by the operator terminal 2 on an upward-facing monitor 13 of the kiosk terminal 1; and

FIG. 11 is a flow chart showing an operation procedure of an audio control operation performed by the kiosk terminal 1.

### DESCRIPTION OF THE PREFERRED EMBODIMENT(S)

A first aspect of the present invention made to achieve the above-described object is a bidirectional video communication system for communication between a kiosk terminal and an operator terminal, the system being configured to bidirectionally transmit a video of a user who operates the kiosk terminal and a video of an operator who operates the operator terminal between the kiosk terminal and the operator terminal, wherein the operator terminal comprises: a communication device configured to perform communication with the kiosk terminal; a camera configured to shoot a frontal-face video of the operator; a microphone configured to pick up a sound of the operator's voice; and a controller, and wherein the kiosk terminal comprises: a communication device configured to perform communication with the operator terminal; a monitor configured to display the frontal-face video of the operator shot by the camera; a speaker configured to output an original sound of the operator's voice picked up by the microphone; a controller, wherein the controller of the kiosk terminal is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

In this configuration, a system is configured such that, in an operator display mode, a kiosk terminal displays a video of an operator so that the operator can directly respond to a user whereas, in an avatar display mode, the kiosk terminal displays a video of an avatar so that the avatar can respond to the user as an operator's proxy. As a result, the system can respond to the user for providing services in either way, through avatar-based communication with an avatar as a human proxy or through face-to-face communication with the operator, depending on the type of service required by the user. Since, even in the avatar display mode, the kiosk terminal outputs an original sound of the operator's voice, the system can avoid providing a feeling of strangeness to the user.

A second aspect of the present invention is the bidirectional video communication system of the first aspect, wherein the controller of the operator terminal is configured to extract feature information from the video of the operator, and then transmit the feature information from the communication device to the kiosk terminal, and wherein the controller of the kiosk terminal is configured to generate a video of the avatar based on the feature information received from the operator terminal.

In this configuration, since the operator terminal transmits the feature information to the kiosk terminal, the amount of communications can be reduced compared to configurations in which the operator terminal transmits a video of the avatar to the kiosk. In addition, since the need for video processing such as encoding and decoding is eliminated, the processing load on the kiosk terminal can be lowered.

A third aspect of the present invention is the bidirectional video communication system of the first or second aspect, wherein the operator terminal comprises: a front-facing camera configured to shoot a face of the operator; and a downward-facing camera configured to shoot hands of the operator, wherein the kiosk terminal comprises: a front-facing monitor configured to display a frontal-face video of the operator shot by the front-facing camera; and an upward-facing monitor configured to display a video of the operator's hands, and wherein the controller of the kiosk terminal is configured to: display either the frontal-face video of the operator or a frontal video of the avatar on the front-facing monitor; and display any one of the video of hands of the operator, the video of hands of the avatar, and an operation screen on the downward-facing monitor.

In this configuration, since the kiosk terminal displays a frontal-face video of the operator and a video of the operator's hands on the front-facing monitor and the upward-facing monitor, respectively, the user can experience a realistic sensation that the user faces the operator over the counter. In addition, since the kiosk terminal is configured to display a video of the operator's hands on the upward-facing monitor, the operator can make an explanation, pointing a finger on a document. Moreover, since the kiosk terminal is configured to display an operation screen on the upward-facing monitor, the user can perform necessary operations on the monitor.

A fourth aspect of the present invention is the bidirectional video communication system of the third aspect, wherein the controller of the kiosk terminal is configured to: display the frontal video of the avatar on the front-facing monitor; and display the video of operator's hands on the upward-facing monitor.

In this configuration, when the operator makes an explanation, pointing a finger on a document, since the kiosk terminal directly displays the video of operator's hands without the use of a video of the avatar's hands, which cannot reproduce delicate movements of hands and fingers, the operator can clearly explain the document.

A fifth aspect of the present invention is the bidirectional video communication system of any of the first to fourth aspects, wherein the controller of the operator terminal is configured to switch a display mode of the monitor between the operator display mode and the avatar display mode in response to an operation performed by the user on the kiosk terminal.

In this configuration, the kiosk terminal is allowed to switch the display mode of the monitor between the operator display mode and the avatar display mode in a proper manner. For example, when a user is only required to perform a simple operation on the screen, the kiosk terminal displays the video of the avatar so that the avatar can respond to the user. As a result, even operators who do not want to expose their faces can do their tasks. When detailed guidance and time are required for a user to perform necessary operations, the kiosk terminal displays the video of the operator so that the operator can directly respond to the user. As a result, the operator can smoothly respond to the user. The system may be configured such that the operator or the user is allowed to switch a display mode of the monitor between the operator display mode and the avatar display mode.

A sixth aspect of the present invention is the bidirectional video communication system of any of the first to fifth aspects, wherein the controller of the kiosk terminal is configured to display on the monitor at least one of guidance information, text information representing transcribed speech of the operator, and shared information which is shared by the user and the operator.

This configuration enables the user to browse the guidance information such as weather forecasts, and recognize the speech of the operator in a text form and also enables the user and the operator to share information, thereby improving the convenience for users.

A seventh aspect of the present invention is a kiosk terminal for bidirectional communication with an operator terminal, the kiosk terminal being configured for bidirectional transmission of a video of a user who operates the kiosk terminal and a video of an operator who operates the operator terminal to and from the operator terminal, the kiosk terminal comprising: a communication device configured to perform communication with the operator terminal; a camera configured to shoot a frontal-face video of the operator; a monitor configured to display a video of the operator shot by a camera of the operator terminal; a speaker configured to output an original sound of the operator's voice picked up by a microphone of the operator terminal; and a controller, wherein the controller is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

In this configuration, in the same manner as the first aspect, the kiosk terminal can respond to the user for providing services in either way, through avatar-based communication with an avatar as a human proxy or through face-to-face communication with the operator, depending on the type of service required by the user.

Embodiments of the present invention will be described below with reference to the drawings.

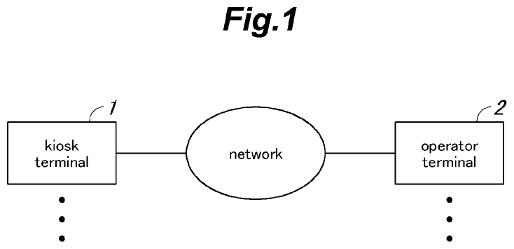

FIG. 1 is a diagram showing a general configuration of a bidirectional video communication system according to an embodiment of the present invention.

The bidirectional video communication system includes a kiosk terminal 1 and an operator terminal 2. The kiosk terminal 1 and the operator terminal 2 are connected to each other via a network such as the Internet, a VPN (Virtual Private Network) or an intranet.

The kiosk terminal 1 is disposed in various facilities and adapted to be operated by a user. The kiosk terminal 1 is configured to transmit a video of the user to the operator terminal 2 and to display a video of an operator received from the operator terminal 2.

The operator terminal 2 is disposed in a facility such as a call center where operators who respond to users are present at all times, and is adapted to be operated by an operator. The operator terminal 2 is configured to transmit a video of an operator to the kiosk terminal 1 and display a video of a user received from the kiosk terminal 1.

The kiosk terminal 1 can provide various services. For example, the kiosk terminal 1 can be disposed in a lobby of a transportation facility such as an airport to thereby provide services such as providing information on nearby sightseeing spots, information on floors in the facility, and information on nearby accommodation facilities. The kiosk terminal 1 can be disposed in a branch of a financial institution such as a bank to thereby provide various services provided at a counter in the branch, such as consulting services associated with opening an account, financial transactions and customer loan. The kiosk terminal 1 is disposed at a reception counter of an accommodation facility such as a hotel to thereby provide various receptionist's services provided by a staff member (concierge). Moreover, the kiosk terminal 1 can be disposed in the entrance lobby of an apartment such as a condominium to thereby provide various services provided by a building janitor.

In this manner, the kiosk terminal 1 can constantly provide various services in place of a person in charge, and thus it becomes possible to improve the quality of services. In addition, since an operator can take charge of a plurality of facilities, it becomes possible to downsize employees.

The kiosk terminal 1 and the operator terminal 2 perform bidirectional communication with each other, transmitting a video of a user and that of an operator to each other. In addition, the kiosk terminal 1 and the operator terminal 2 perform bidirectional communication with each other, transmitting to each other operation information which the user and the operator enter on the kiosk terminal 1 and the operator terminal 2, respectively.

In particular, the terminals can transmit confidential information (for example, personal information such as user's name and address, or a financial institution account number) to each other. For transmission of such confidential information, since a service provider already provides a highly secure network, the terminals may be configured to transmit confidential information other than video via the existing highly secure network while transmitting video via a different network. In this configuration, a necessary security for transmission of confidential information is ensured by using the existing network, whereas video contents, which require a large amount of communication in transmission, can be transmitted over a different network, thereby preventing an increase in the load on the existing network.

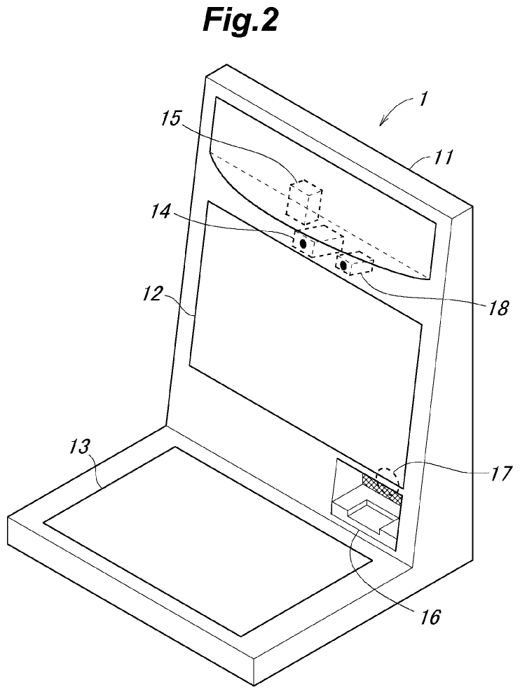

Next, the kiosk terminal 1 will be described. FIG. 2 is a perspective view showing the kiosk terminal 1.

The kiosk terminal 1 includes a housing 11, a front-facing monitor 12, an upward-facing monitor 13, a front-facing camera 14, a downward-facing camera 15, an IC card reader 16, a speaker 17, and a microphone 18.

The front-facing monitor 12 is arranged with its screen facing forward, and the upward-facing monitor 13 is arranged with its screen facing upward. In addition, the upward-facing monitor 13 includes a touchscreen so that users can operate the touchscreen to invoke actions.

The front-facing camera 14 is used to shoot a video of a user's upper body including the user's face from front. The downward-facing camera 15 is used to shoot a video of where the user's hands are placed; that is, shoot a video of the user's hand placed on the upward-facing monitor 13 from above. The user points a finger on the screen of the upward-facing monitor 13, and this situation is shot by the downward-facing camera 15.

The IC card reader 16 reads an IC card carried by the user.

The speaker 17 outputs voice of the operator. The microphone 18 picks up a sound of the user's voice.

The kiosk terminal 1, which is configured this way, is placed on a base such as a counter so that a user can operate the kiosk terminal 1 while sitting on the chair or standing.

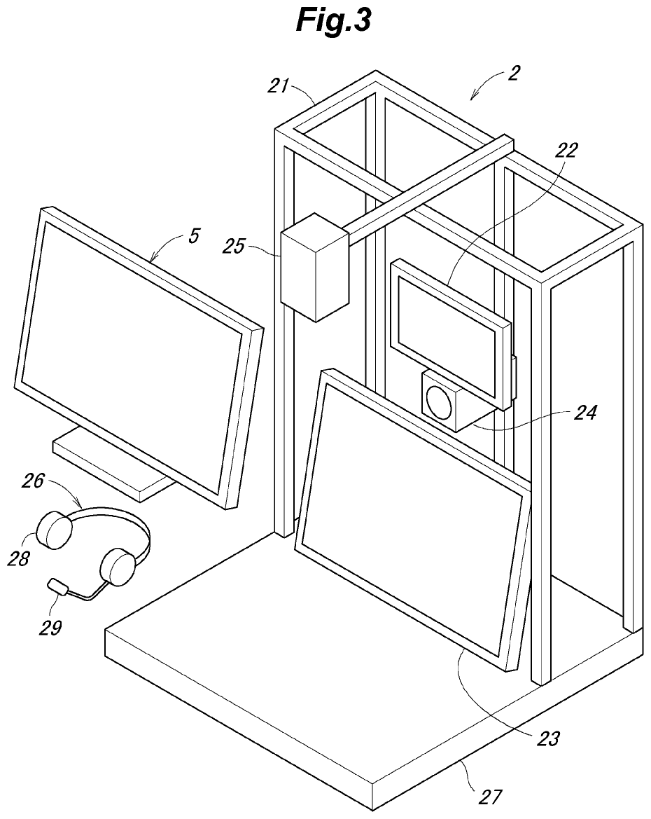

Next, the operator terminal 2 will be described. FIG. 3 is a perspective view showing the operator terminal 2.

The operator terminal 2 includes a frame 21, a first monitor 22, a second monitor 23, a front-facing camera 24, a downward-facing camera 25, a headset 26, and a table 27.

The first monitor 22 is supported by the frame 21 so as to be located at a predetermined height. The second monitor 23 includes a touchscreen so that an operator can operate the touchscreen to invoke actions.

The front-facing camera 24 is used to shoot an operator's upper body including the face from front. The downward-facing camera 25 is used to shoot a video of where the operator's hands can be placed; that is, shoot a video of the operator's hand placed on the table 27 from above. The operator, putting a document such as a brochure on the table, explains the document while pointing a finger on the document, and this situation is shot by the downward-facing camera 25.

The headset 26 includes a speaker 28 and a microphone 29. The speaker 28 outputs voice of the user. The microphone 29 picks up a sound of the operator's voice.

The operator terminal 2 is also provided with a monitor 5. The monitor 5 displays a screen of an application running on the operator terminal 2 or a PC (not shown). The operator terminal 2 shares the screen of the application with the kiosk terminal 1 so that the same screen is displayed on the upward-facing monitor 13 of the kiosk terminal 1 (screen sharing function). The monitor 5 includes a touchscreen, and an operator can draw on the screen by handwriting (whiteboard function).

In a call center, each of the operators uses the operator terminal 2 not only to provide face-to-face response services to a user through video and voice, but also to provide telephone reception services by responding to a user only by voice over the telephone. Thus, the operator terminal 2 is also equipped with a monitor (not shown) for telephone reception services.

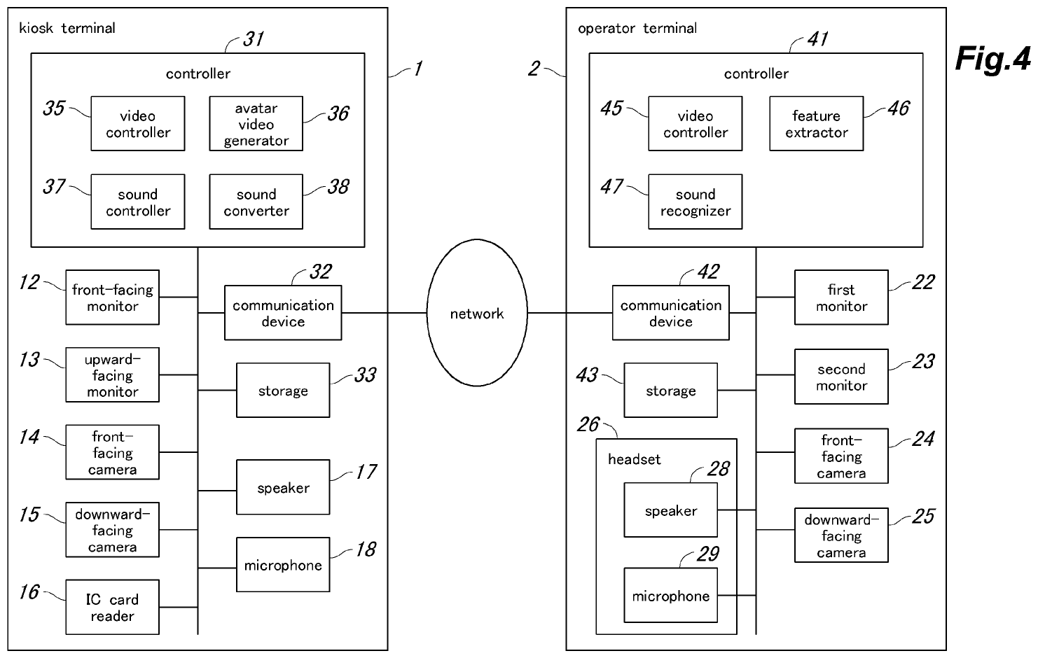

Next, schematic configurations of the kiosk terminal 1 and the operator terminal 2 will be described. FIG. 4 is a block diagram showing schematic configurations of the kiosk terminal 1 and the operator terminal 2.

As described above, the kiosk terminal 1 includes the front-facing monitor 12, the upward-facing monitor 13, the front-facing camera 14, the downward-facing camera 15, the IC card reader 16, the speaker 17, and the microphone 18. The kiosk terminal 1 also includes a controller 31, a communication device 32, and a storage 33.

The communication device 32 performs communication with the operator terminal 2 via a network.

The storage 33 stores programs executable by a processor, which implements the controller 31. The storage 33 stores avatar model information required for an avatar video generator 36 to generate an avatar video.

The controller 31 includes a screen controller 35, the avatar video generator 36, a sound controller 37, and a sound converter 38. The controller 31 is configured by the processor, and each unit of the controller 31 is implemented by executing a program stored in the storage 33 by the processor.

The screen controller 35 controls the screens displayed on the front-facing monitor 12 and the upward-facing monitor 13. In the present embodiment, when a frontal-face video of the operator is received from the operator terminal 2, the screen controller 35 displays the frontal-face video of the operator on the front-facing monitor 12. When a video of the operator's hands is received from the operator terminal 2, the screen controller 35 displays the video of the operator's hands on the upward-facing monitor 13.

When feature information including facial features of the operator is received from the operator terminal 2, the screen controller 35 causes the avatar video generator 36 to generate a frontal video of an avatar, and displays the frontal video of the avatar on the front-facing monitor 12. Furthermore, when feature information including features of the operator's hands is received from the operator terminal 2, the screen controller 35 causes the avatar video generator 36 to generate a video of the avatar's hands, and displays the video of the avatar's hands on the upward-facing monitor 13.

In addition, when text information for subtitles is received from the operator terminal 2, the screen controller 35 generates a subtitles video and displays the subtitles video in an overlaid manner on the frontal video of the avatar. When guidance information is received from the operator terminal 2, the screen controller 35 generates a video image for strip-shaped information indicating zone and displays the video image as a superimposed video image over the frontal video of the avatar.

The avatar video generator 36 generates, based on the feature information (tracking information) received from the operator terminal 2, a video of an avatar (by fitting and rendering) in which the avatar (mascot) moves in accordance with the movement of the operator's face. In the present embodiment, the avatar video generator 36 generates, based on feature information including features of the operator's face, a frontal-face video of the avatar, which reproduces movements of the operator's face, and also generates, based on feature information including features of the operator's hands, a video of the avatar's hands, which reproduces movements of the operator's hands.

The sound controller 37 controls a sound of the voice output from the speaker 17. In the present embodiment, the sound controller 37 selects either the original sound of the operator's voice received from the operator terminal 2 or a converted sound generated by a sound converter 38 through the conversion of the operator's voice, and outputs the selected sound from the speaker 17, the selection of the sound to be output being made depending on whether or not the sound conversion function is enabled.

The sound converter 38 converts the original sound of the operator's voice received from the operator terminal 2 into a different sound of voice suited for the avatar to be used. To achieve this sound conversion, the sound converter 38 may use any of the known sound conversion techniques such as voice quality conversion using a deep learning technology.

Moreover, the controller 31 performs connection control to make a connection to the operator terminal 2, and also performs video transmission control for real-time transmission/reception of videos of the user and the operator which are shot by the kiosk terminal 1 and the operator terminal 2, respectively.

As described above, the operator terminal 2 includes the first monitor 22, the second monitor 23, the front-facing camera 24, the downward-facing camera 25, and the headset 26. The operator terminal 2 also includes a controller 41, a communication device 42, and a storage 43.

The communication device 42 performs communication with the kiosk terminal 1 via the network.

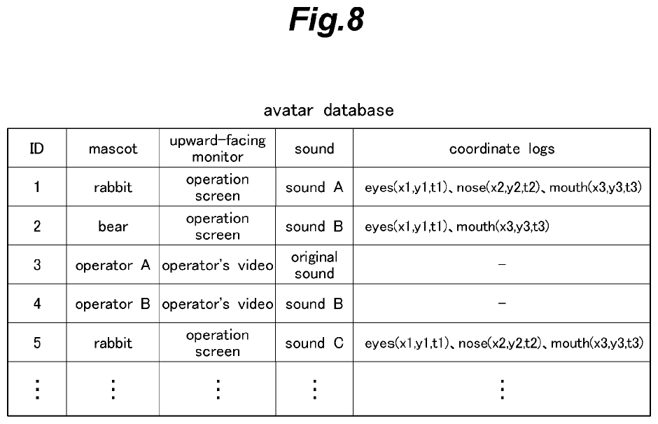

The storage 43 stores programs executable by a processor, which implements the controller 41. The storage 43 also stores records registered in an avatar database, the records being associated with situations each time an avatar is displayed on kiosk terminal 1 (see FIG. 8).

The controller 41 includes a screen controller 45, a feature extractor 46, and a sound recognizer 47. The controller 41 is configured by a processor, and each unit of the controller 41 is implemented by executing a program stored in the storage 43 by the processor.

The screen controller 45 controls screens displayed on the front-facing monitor 12 and the upward-facing monitor 13 of the kiosk terminal 1. In the present embodiment, as part of control on screens displayed on the front-facing monitor 12 of the kiosk terminal 1, the screen controller 45 switches a display mode of the front-facing monitor between an operator display mode in which a frontal-face video of the operator is displayed and an avatar display mode in which a frontal-face video of an avatar is displayed. Also, as part of control on screens displayed on the upward-facing monitor 13 of the kiosk terminal 1, the screen controller 45 switches a display mode of the upward-facing monitor between an operator display mode in which a video of the operator's hands is displayed, an avatar display mode in which a video of the avatar's hands is displayed, an operation screen mode in which operations screens (such as a menu screen) are displayed, and a screen sharing mode in which an application screen is displayed.

In the present embodiment, the display modes of the front-facing monitor 12 and the upward-facing monitor 13 of the kiosk terminal 1 are switched according to the user's operation on the kiosk terminal 1. However, the system may be configured such that the operator is allowed to select the display modes.

The feature extractor 46 extracts feature information including features of the operator's face; that is, position information records (coordinates) of a plurality of feature points on the face, from the frontal-face video of the operator shot by the front-facing camera 24. Moreover, the feature extractor 46 extracts feature information including features of the operator's hands; that is, position information records (coordinates) of a plurality of feature points on the hands, from the video of the operator's hands shot by the downward-facing camera 25.

The sound recognizer 47 performs sound recognition on the sound of the operator's voice picked up by the microphone 29, thereby outputting transcribed text information.

Moreover, the controller 41 performs connection control to make a connection to the kiosk terminal 1, and also performs video transmission control for real-time transmission/reception of videos of the user and the operator which are shot by the kiosk terminal 1 and the operator terminal 2, respectively.

It should be noted that the operator terminal 2 may be provided with a scanner used for scanning a document(s) an operator has. In addition, the operator terminal 2 may be provided with an IC card reader used to authenticate an operator who operates the terminal as an authorized operator. Moreover, the kiosk terminal 1 may be provided with a printer used to print out a document transmitted from the operator terminal 2 or information displayed on the screen.

The second monitor 23 may be configured by a tablet PC; that is, configured such that the controller 41, the communication device 42, and the storage 43 are accommodated in a housing of the second monitor 23.

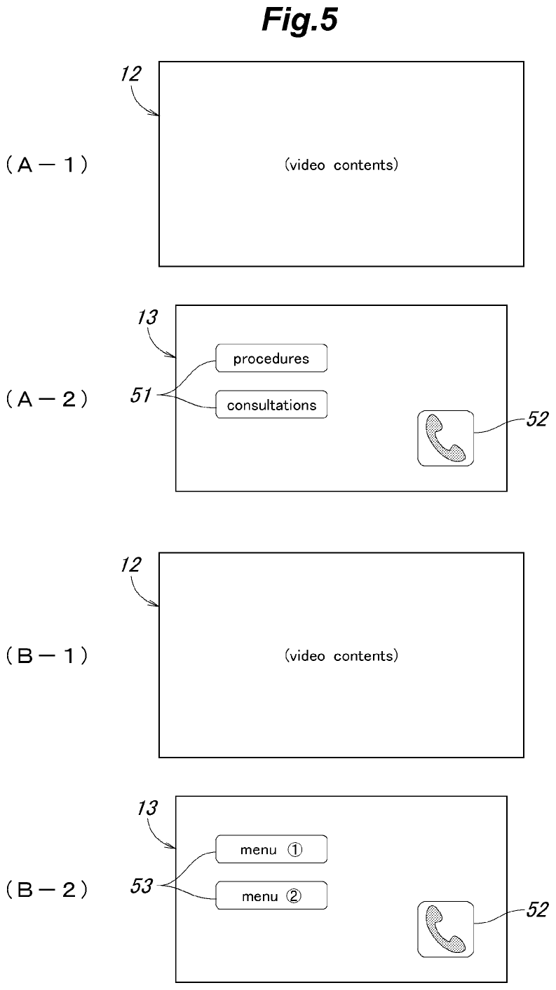

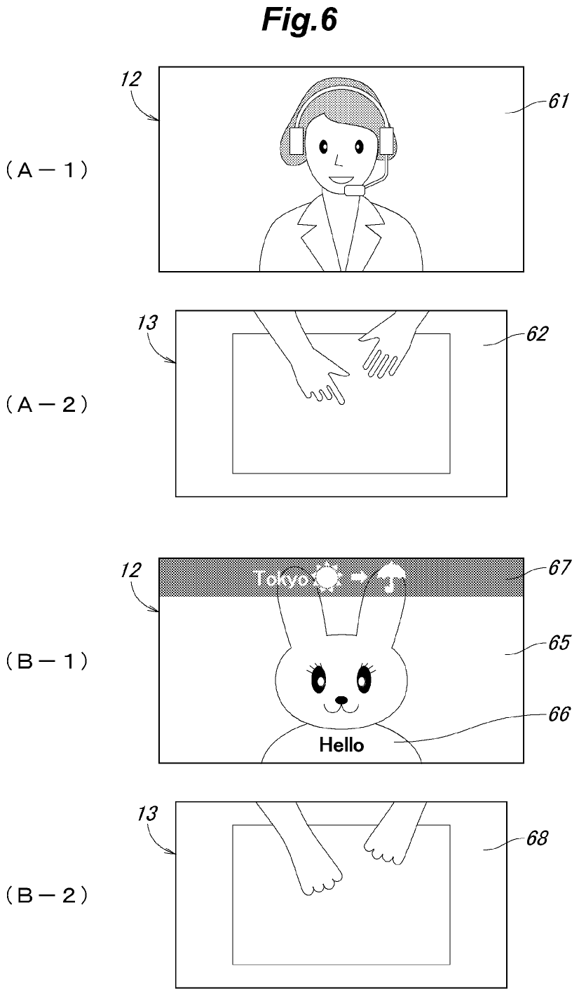

Next, screens displayed on the kiosk terminal 1 will be described. FIGS. 5 and 6 are explanatory diagrams showing the screens displayed on the kiosk terminal 1.

In the kiosk terminal 1, the front-facing monitor 12 operates as digital signage during standby (before connecting to the operator terminal 2), and as shown in FIG. 5(A-1), the kiosk terminal 1 displays on the front-facing monitor 12 video contents relating to advertisements such as recommended plans and guide maps of facilities.

Also, during standby, as shown in FIG. 5(A-2), a main menu screen (operation screen) is displayed on the upward-facing monitor 13. The main menu screen includes on-screen operation buttons 51 corresponding to various menu items. In the present embodiment, the operation buttons include selection buttons corresponding to two service menus, “procedures” and “consultations.” When a user selects the “procedures” button, the display mode is set to the operator display mode and the screen transitions to operation screens (FIGS. 6(A-1) and 6(A-2)). When a user selects the “consultations” button, the display mode is set to the avatar display mode and the screen transitions to avatar screens (FIGS. 6(B-1) and 6(B-2)).

The “procedures” button should be selected when a user takes procedures such as opening of an account. In this case, since a user only needs to perform simple screen operations and an operator normally does not need to give face to face guidance to the user, the display mode is set to the avatar display mode so that the avatar in the video responds to the user. The “consultations” button should be selected when a user consults an operator on e.g. a loan contact or a trust contract. In this case, a user needs detailed guidance and time and thus an operator needs to give face to face guidance to the user, the display mode is set to the operator display mode so that the operator in the video responds to the user. In other embodiments, the system may be configured such that, when a user selects a certain service from service menus, a selection screen (not shown) is displayed for the user's selection of the display mode between the avatar display mode and the operator display mode.

The main menu screen displayed on the upward-facing monitor 13 also includes a call button 52. When the user operates the call button 52, the kiosk terminal 1 makes a connection to the operator terminal 2, and the display mode is set to the operator display mode so that the screen transitions to the operator screens (FIGS. 6(A-1) and 6(A-2)). As a result, even when the “procedures” button is selected so that a user only needs to perform simple screen operations, the user can be given guidance from the operator.

In the operator display mode, before the screen transitions to the operator screen, the kiosk terminal may display an inquiry screen to inquire whether or not a user wishes to directly interact with an operator, and only if the user approves the direct interaction with the operator, the screen transitions to the operator screen.

The system may be configured such that, when a user selects a service menu on the main menu screen, the screen transitions to a submenu screen as necessary as shown in FIG. 5(B-2). The submenu screen includes operation button 53 corresponding to respective submenu service items. In addition, the submenu screen includes a call button 52 in a similar manner to the main menu screen (see FIG. 5A-2)).

When the kiosk terminal 1 is connected to the operator terminal 2, in the operator display mode, the front-facing monitor 12 displays a frontal-face video 61 of the operator shot by the front-facing camera 24 of the operator terminal 2 as shown in FIG. 6(A-1), and simultaneously, the upward-facing monitor 13 displays a video 62 of the operator's hands shot by downward-facing camera 25 of the operator terminal 2 as shown in FIG. 6(A-2).

In the avatar display mode, the front-facing monitor 12 displays a frontal video 65 of the avatar as shown in FIG. 6(B-1). Based on feature information including features extracted from the frontal-face video of the operator, the kiosk terminal 1 generates the frontal video 65 of the avatar, in which the avatar's face moves in accordance with the movement of the operator's face.

In the avatar display mode, the subtitles 66 (transcribed text information indicating zone) are displayed in an overlaid manner on the frontal video 65 of the avatar. The subtitles include texts composed of transcribed speech of the operator. A video image for strip-shaped information indicating zone 67 (guidance information indicating zone) is displayed in a superimposed manner on the frontal video 65 of the avatar. The strip-shaped information indicating zone 67 can indicate various types of information such as weather forecasts, traffic condition information and stock price information.

When the front-facing monitor is set to the avatar display mode, the upward-facing monitor is in any of the avatar display mode, the operator display mode, and the operation screen display mode.

In the avatar display mode, as shown in FIG. 6(B-2), a video 68 of the avatar's hands is displayed on the upward-facing monitor 13. Based on the feature information including features extracted from the video of the operator's hands, the kiosk terminal generates the video 68 of the avatar's hands, in which the avatar's hands move in accordance with the movement of the operator's hands.

In the operator display mode, the video 62 of the operator's hands is displayed on the upward-facing monitor 13 in the same manner as the example shown in FIG. 6(A-2). In the operation screen display mode, the operation screen is displayed in the same manner as the example shown in FIG. 5(B-2).

In the screen sharing mode, the upward-facing monitor 13 displays a screen of an application run on the operator terminal 2 or a PC (not shown) at the operator's site. The kiosk terminal 1 shares the screen of the application with the operator terminal 2 so that the same screen is displayed on the operator terminal 2 (screen sharing function). Also, the user can draw on the screen of the application by handwriting (whiteboard function).

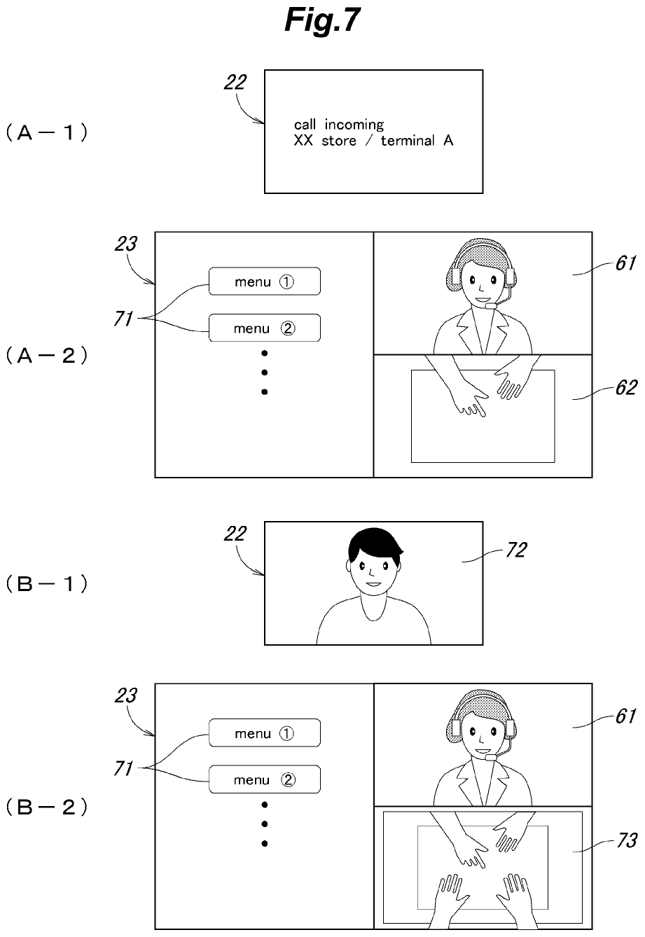

Next, screens displayed on the operator terminal 2 will be described. FIG. 7 is an explanatory diagram showing the screens displayed on the operator terminal 2.

During standby, the first monitor 22 of the operator terminal 2 displays a standby screen, and when the user operates the call button 52 (see FIG. 5(A-2)) at the kiosk terminal 1, a call incoming screen as shown in FIG. 7(A-1) is displayed on the first monitor 22. The call incoming screen shows information on the counterpart kiosk terminal 1 (such as disposed location or terminal name).

During standby, an operation screen as shown in FIG. 7(A-2) is displayed on the second monitor 23 of the operator terminal 2. The operation screen shows operation buttons 71 corresponding to various menu items such as those used to control the operator terminal 2 and give instructions to the kiosk terminal 1.

The second monitor 23 displays the frontal-face video 61 of the operator shot by the front-facing camera 24 of the operator terminal 2 and the video 62 of the operator's hands shot by downward-facing camera 25 of the operator terminal 2, which are both same as those displayed on the kiosk terminal 1. The video 62 of the operator's hands can be switched between the video displayed in the original form and that in a vertically flipped form.

When the operator terminal 2 is connected to the kiosk terminal 1, the first monitor 22 displays a frontal-face video 72 of the user shot by the front-facing camera 14 of the kiosk terminal 1 as shown in FIG. 7(B-1). The first monitor 22 is supported by the frame 21 so as to be located at a predetermined height (see FIG. 3), which allows the height of the operator's eyes to match that of the user's eyes.

As shown in FIG. 7(B-2), the second monitor 23 displays the operation buttons 71 in the same manner as during standby. The second monitor 23 also displays the frontal-face video 61 of the operator in the same manner as during standby. The screen displayed on the second monitor can be switched between the frontal-face video 61 of the operator and the video of the operator's hands. The second monitor 23 displays a video 73 of the user's hands shot by the downward-facing camera 15 of the kiosk terminal 1 concurrently with displaying the video of the operator's hands. The video 73 of the user's hands can be switched between the video displayed in the original form and that in a vertically flipped form.

The video 73 of the user's hands displayed on the second monitor 23 shows a situation in which the user points a finger on a document such as a brochure on the upward-facing monitor 13 of the kiosk terminal 1, so that the user and the operator can interact with each other while pointing their fingers on the document.

In the present embodiment, the operator terminal 2 is configured such that the first monitor 22 displays the frontal-face video 72 of the user, and the second monitor 23 displays the video 73 of the user's hands. However, the operator terminal 2 may be configured such that a single monitor displays the frontal-face video 72 of the user and the video 73 of the user's hands. In this case, the operator can experience a realistic sensation that the operator faces the user over the counter.

Next, an avatar database managed by the operator terminal 2 will be described. FIG. 8 is an explanatory diagram showing records registered in the avatar database.

The operator terminal 2 registers records in the avatar database, the records being associated with situations each time an avatar is displayed on kiosk terminal 1. Registered in the avatar database (table) are a set of records for each event in which an avatar is displayed, the set of records including a record ID, a mascot used as an avatar, what is displayed in the upward-facing monitor 13, a type of output sound, and coordinate logs.

The coordinate logs (history records of feature information) are coordinates (position information records) of future points on the face extracted from the frontal-face video of the operator. The coordinate logs are accumulated to enable reproduction of videos of avatars which were displayed on the kiosk terminal 1 in the past. In this way, the amount of data to be recorded can be greatly reduced compared to cases where videos of operators and/or avatars are recorded.

Part of an avatar to be moved can vary depending on the type of mascot as an avatar. For example, the system may be configured such that, in the case of a “rabbit” avatar, its eyes, nose and mouth are moved, and in the case of a “bear” avatar, its eyes and nose are moved while its mouth is not moved. In such configurations, parts to be moved; that is, parts where feature information is to be extracted may be registered in the database.

In some cases, parts of an avatar to be moved may be those other than the avatar's face. For example, shoulders of an avatar may be parts to be moved. In this case, feature information including features of the shoulders may be extracted from a frontal-face video of an operator.

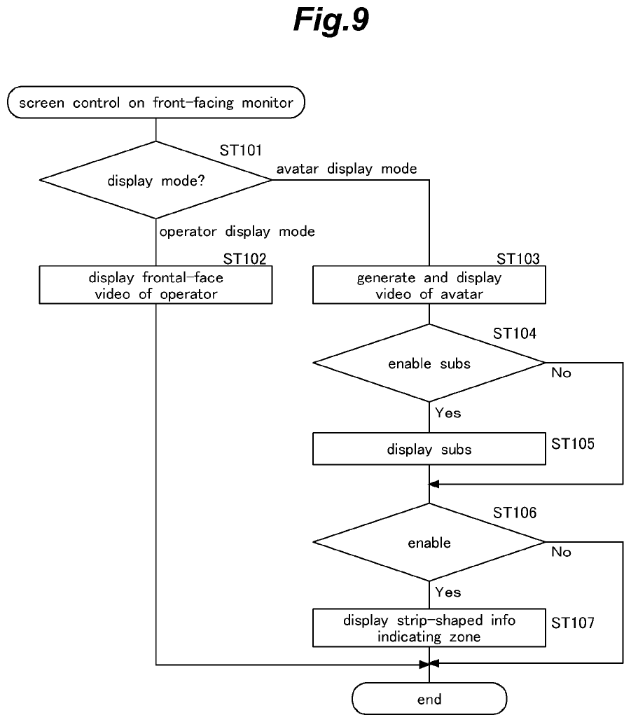

Next, a screen control operation performed by an operator terminal 2 on the front-facing monitor 12 of a kiosk terminal 1 will be described. FIG. 9 is a flow chart showing an operation procedure of the screen control operation on the front-facing monitor 12.

First, the operator terminal 2 determines the current display mode of the front-facing monitor 12 of the kiosk terminal 1 (ST101). If the front-facing monitor 12 is in the operator display mode, the operator terminal 2 transmits a frontal-face video of the operator shot by the front-facing camera 24 to the kiosk terminal 1 to thereby display the frontal-face video of the operator on the front-facing monitor 12 of the kiosk terminal 1 (ST102).

If the front-facing monitor 12 is in the avatar display mode, the operator terminal 2 extracts feature information including features of the operator's face from the frontal-face video of the operator shot by the front-facing camera 24 and transmits the feature information to the kiosk terminal 1 to thereby cause the kiosk terminal 1 to generate, based on the feature information, a frontal video of an avatar and display it on the front-facing monitor 12 (ST103).

If a subtitle function is enabled (Yes in ST104), the operator terminal 2 converts a sound of the operator's voice picked up by the microphone 29 into transcribed text information through sound recognition, and transmits the text information to the kiosk terminal 1 to thereby cause the kiosk terminal 1 to generate, based on the text information, a video image of subtitles; that is, texts composed of transcribed speech of the operator and display the video image in an overlaid manner on the frontal video of the avatar (ST105).

If a strip-shaped information indicating function is enabled (Yes in ST106), the operator terminal 2 acquires pieces of information such as weather forecasts from a server (not shown), and transmits the acquired information to the kiosk terminal 1 to thereby cause the kiosk terminal 1 to generate an strip-shaped visualized image of the information and display the image in a superimposed manner on the frontal video of the avatar (ST107).

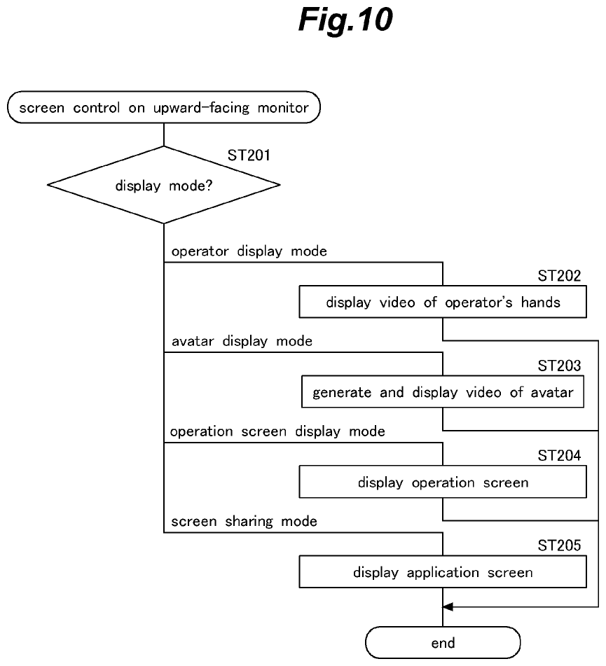

Next, a screen control operation performed by an operator terminal 2 on the upward-facing monitor 13 of a kiosk terminal 1 will be described. FIG. 10 is a flow chart showing an operation procedure of the screen control operation on the upward-facing monitor 13.

First, the operator terminal 2 determines the current display mode of the upward-facing monitor 13 of the kiosk terminal 1 (ST201). If the upward-facing monitor 13 is in the operator display mode, the operator terminal 2 transmits a video of the operator's hands shot by the downward-facing camera 25 to the kiosk terminal 1 to thereby display the video of the operator's hands on the upward-facing monitor 13 of the kiosk terminal 1 (ST202).

If the upward-facing monitor 13 is in the avatar display mode, the operator terminal 2 extracts feature information including features of the operator's hands from the video of the operator's hands shot by the downward-facing camera 25 and transmits the feature information to the kiosk terminal 1 to thereby cause the kiosk terminal 1 to generate, based on the feature information, a video of hands of an avatar and display it on the upward-facing monitor 13 (ST203).

If the upward-facing monitor 13 is in the operation screen mode, the operator terminal 2 generates an operation screen (such as a menu screen) and transmits the operation screen to the kiosk terminal 1 to thereby cause the kiosk terminal 1 to display it on the upward-facing monitor 13 (ST204).

If the upward-facing monitor 13 is in the screen sharing mode, the operator terminal 2 generates a screen of an application (application screen) and transmits the application screen to the kiosk terminal 1 to thereby cause the kiosk terminal 1 to display it on the upward-facing monitor 13 (ST205).

Then, when receiving the operator's handwritten operation records, the operator terminal 2 generates, based on the operator's operation records, a video image of the operator's handwritten operation and displays it in a superimposed manner on the application screen. When receiving user's handwritten operation records transmitted from the kiosk terminal 1, the operator terminal 2 generates, based on the user's operation records, a video image of the user's handwritten operation and displays it in a superimposed manner on the application screen.

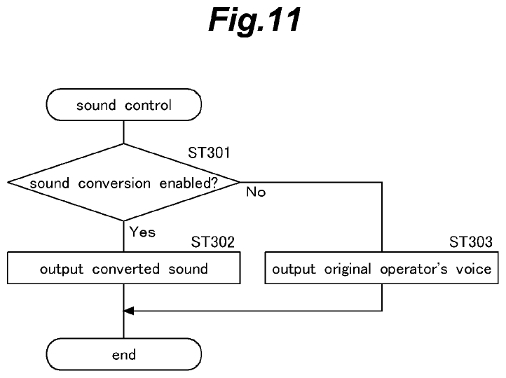

Next, an audio control operation performed by the kiosk terminal 1 will be described. FIG. 11 is a flow chart showing an operation procedure of the audio control operation.

First, the kiosk terminal 1 determines whether or not a sound conversion function is enabled (ST301). If the sound conversion function is enabled (Yes in ST301), the kiosk terminal 1 converts the original sound of the operator's voice received from the operator terminal 2 into a converted voice sound and outputs it from the speaker 17 (ST302).

If the sound conversion function is disabled (No in ST301), the kiosk terminal 1 outputs from the speaker 17 the original sound of the operator's voice received from the operator terminal 2 (ST303).

When the front-facing monitor 12 of the kiosk terminal 1 is in the avatar display mode, the voice conversion function is set to be enabled, whereas, when the front-facing monitor 12 is in the operator display mode, the voice conversion function is set to be disabled. In some cases, the system may be configured such that, when the front-facing monitor 12 is in the avatar display mode and the subtitle function is enabled, the kiosk terminal 1 outputs no sound. In other embodiments, the kiosk terminal 1 may be configured such that an operation button or other control to enable the subtitle function is provided on the screens so that a user can always enable the subtitle function regardless of the current display mode of the monitor, thereby allowing for providing a user with a decreased hearing or hearing deficiency with guidance associated with various procedures.

While specific embodiments of the present invention are described herein for illustrative purposes, the present invention is not limited to the specific embodiments. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present invention.

### INDUSTRIAL APPLICABILITY

A bidirectional video communication system and a kiosk terminal according to the present invention achieve an effect of enabling the kiosk terminal to respond to a user for providing services in either way, through avatar-based communication with an avatar as a human proxy or through face-to-face communication with an operator, depending on the type of service required by the user, and are useful as a bidirectional video communication system for communication between a kiosk terminal and an operator terminal, the system being configured to bidirectionally transmit a video of a user who operates the kiosk terminal and a video of an operator who operates the operator terminal between the kiosk terminal and the operator terminal, and a kiosk terminal used in the system.

### Glossary

1 kiosk terminal
2 operator terminal
12 front-facing monitor
13 upward-facing monitor
14 front-facing camera
15 downward-facing camera
17 speaker
18 microphone
22 first monitor
23 second monitor
24 front-facing camera
25 downward-facing camera
26 headset
28 speaker
29 microphone
31 controller
32 communication device
33 storage
41 controller
42 communication device
43 storage
61 frontal-face video of operator
62 video of operator's hands
65 frontal video of avatar
66 subtitles
67 strip-shaped information indicating zone
68 video of avatar's hands

1. A bidirectional video communication system for communication between a kiosk terminal and an operator terminal, the system being configured to bidirectionally transmit a video of a user who operates the kiosk terminal and a video of an operator who operates the operator terminal between the kiosk terminal and the operator terminal,
wherein the operator terminal comprises:
a communication device configured to perform communication with the kiosk terminal;
a camera configured to shoot a frontal-face video of the operator;
a microphone configured to pick up a sound of the operator's voice; and
a controller, and
wherein the kiosk terminal comprises:
a communication device configured to perform communication with the operator terminal;
a monitor configured to display the frontal-face video of the operator shot by the camera;
a speaker configured to output an original sound of the operator's voice picked up by the microphone;
a controller,
wherein the controller of the kiosk terminal is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.

2. The bidirectional video communication system according to claim 1, wherein the controller of the operator terminal is configured to extract feature information from the video of the operator, and then transmit the feature information from the communication device to the kiosk terminal, and
wherein the controller of the kiosk terminal is configured to generate a video of the avatar based on the feature information received from the operator terminal.

3. The bidirectional video communication system according to claim 1, wherein the operator terminal comprises:
a front-facing camera configured to shoot a face of the operator; and
a downward-facing camera configured to shoot hands of the operator,
wherein the kiosk terminal comprises:
a front-facing monitor configured to display a frontal-face video of the operator shot by the front-facing camera; and
an upward-facing monitor configured to display a video of the operator's hands, and
wherein the controller of the kiosk terminal is configured to:
display either the frontal-face video of the operator or a frontal video of the avatar on the front-facing monitor; and
display any one of the video of hands of the operator, the video of hands of the avatar, and an operation screen on the downward-facing monitor.

4. The bidirectional video communication system according to claim 3, wherein the controller of the kiosk terminal is configured to:
display the frontal video of the avatar on the front-facing monitor; and
display the video of operator's hands on the upward-facing monitor.

5. The bidirectional video communication system according to claim 1, wherein the controller of the operator terminal is configured to switch a display mode of the monitor between the operator display mode and the avatar display mode in response to an operation performed by the user on the kiosk terminal.

6. The bidirectional video communication system according to claim 1, wherein the controller of the kiosk terminal is configured to display on the monitor at least one of guidance information, text information representing transcribed speech of the operator, and shared information which is shared by the user and the operator.

7. A kiosk terminal for bidirectional communication with an operator terminal, the kiosk terminal being configured for bidirectional transmission of a video of a user who operates the kiosk terminal and a video of an operator who operates the operator terminal to and from the operator terminal, the kiosk terminal comprising:
a communication device configured to perform communication with the operator terminal;
a camera configured to shoot a frontal-face video of the operator;
a monitor configured to display a video of the operator shot by a camera of the operator terminal;
a speaker configured to output an original sound of the operator's voice picked up by a microphone of the operator terminal; and
a controller,
wherein the controller is configured such that, in an operator display mode, the controller displays the video of the operator on the monitor concurrently with outputting the original sound of the operator's voice from the speaker whereas, in an avatar display mode, the controller displays a video of an avatar, the avatar being generated based on feature information including operator's features extracted from the video of the operator, concurrently with outputting a converted sound from the speaker, the converted sound being generated by converting the original sound of the operator's voice to one suited for the avatar.
